(19) United States
(12) Patent Application Publication
(10) Pub. No.: US 2004/0132343 A1
(43) Pub. Date: Jul. 8, 2004

(54) Adapter for a telephone holder of a hands-free device

(76) Inventor: Gisela Bisplinghoff, Schloss Holte Stukenbrock (DE)

Correspondence Address: Attn: Arlene J. Powers, Samuels, Gauthier & Stevens, LLP, Suite 3300, 225 Franklin Street, Boston, MA, 02110, US

(21) Appl. No.: 10/737,424

(22) Filed: Dec. 15, 2003

Related U.S. Application Data
(63) Continuation of application No. PCT/EP02/06911, filed on Jun. 22, 2002.

(30) Foreign Application Priority Data
Jun. 28, 2001 (DE) 10131335.7

(51) Int. Cl. H01R 25/00

(52) U.S. Cl. 439/638

(57) ABSTRACT

The invention relates to an adapter for a telephone holder, especially for a telephone holder mounted in a vehicle. Said adapter comprises a locking mechanism for locking the adapter to the telephone holder in a detachable manner, and a contact bank which can be brought into contact with contact elements provided on the telephone holder. A mobile telephone can be inserted into the adapter and can be detachably connected to the same by means of locking elements. In the inserted position, a connection is established between the contact elements on the mobile telephone and the contact element on the adapter, the mobile telephone being held on the telephone holder in an operational manner by means of the adapter. The inventive adapter enables existing telephone holders to receive different mobile telephones or new mobile telephones.

### BACKGROUND OF THE INVENTION

1. Field of the Invention

The invention relates to an adapter for a telephone holder of a hands-free device, specifically, for a telephone holder mounted in a vehicle.

2. Description of the Prior Art

Telephone holders for cellular telephones, in particular those installed in vehicles, already exist. In light of the fact that many countries have passed legislation requiring the use of hands-free systems in vehicles so as to keep distraction of the driver to a minimum when the telephone is used, there exists a multiplicity of telephone holders for installation in vehicles. Usually, these telephone holders may be employed with only one type, or a few types, of cellular telephones since new products usually have altered dimensions or different connecting elements. Since cellular telephones are usually replaced after only a few years, while a vehicle has a much longer service life, a new telephone holder is acquired simultaneously with the purchase of the new cellular telephone—a requirement that is inconvenient and expensive. In addition, in the case of users such as married couples, for example, who own different types of cellular telephones, only one cellular telephone may be used in the installed telephone holder.

The goal of the invention is therefore to eliminate the above disadvantages by creating an adapter for a telephone holder of a hands-free unit, by which adapter the telephone holder may be employed with different types or new types of cellular telephones, thereby eliminating the requirement of replacing telephone holders when a new cellular telephone is purchased.

### SUMMARY OF THE INVENTION

This goal is achieved by an adapter for the telephone holder of a hands-free device, which adapter has the features indicated in claim 1.

As a first feature according to the invention, the adapter has a locking mechanism to detachably lock the adapter to the telephone holder, thereby engaging contact elements of the telephone holder through a contact strip on the adapter. In addition, a cellular telephone may be inserted into the adapter, which phone is detachably connectable to the adapter through additional locking elements, a connection being created in the inserted position between contact elements on the cellular telephone and contact elements on the adapter so that the cellular telephone is held by the adapter on the telephone holder in order to retain its functionality. As a result, such cellular telephones may be used on the telephone holder of the hands-free device which were not actually designed for use on this telephone holder. This capability applies both to new cellular telephones as well as to cellular telephones of a different type, or from a different manufacturer. The adapter may be purchased as an accessory component for a cellular telephone or for a telephone holder, thus allowing different cellular telephones to be employed in succession on the telephone holder. The great advantage for the user is the fact that no new telephone holder or new hands-free device need be acquired or installed; instead, the only requirement is that an adapter be inserted in the telephone holder by a few effortless procedures. Another advantage is that the frequently long delivery times for hands-free devices compatible with cellular telephones are significantly reduced since as a single component the adapter is able to be supplied within significantly shorter time periods.

According to a preferred embodiment of the invention, a circuit board is interconnected between the contact elements on the adapter and the contact strip, by which circuit board the requisite adaptations are implemented in regard to transmitting signals and power. Since specific cellular telephones here have different requirements, this adaptation is implemented automatically by the circuit board. In addition, the adapter may be provided in the form of a compact unit by accommodating the circuit board in a plastic case. To this end, the adapter is preferably of a box-like shape and comprises a holding fixture which partially encloses a cellular telephone.

According to one advantageous embodiment of the invention, lateral recesses are provided on the adapter into which locking elements may be inserted to secure the adapter. In order to facilitate insertion of the adapter, support strips are preferably provided on the telephone holder so that the adapter can be slipped on via projections.

To provide a secure connection between the contacts, the box-shaped adapter includes contact strips on the end face by which the adapter may be slipped on or pivoted on to the contact elements of the telephone holder. To enable the pivoting-on procedure, recesses are preferably provided adjacent to the contact strips, which recesses engage projections on the telephone holder, so that the adapter is first inserted into the telephone holder, then pivoted down so as to effect locking. In addition, a projecting antenna plug may be provided in the base of the telephone holder, which plug is insertable into a jack facing the telephone holder such that the antenna plug has both a locking function as well as a transmitting function.

A pocket-shaped holding fixture is preferably provided to securely accommodate the cellular telephone, in which fixture clamping elements are provided to secure the cellular telephone, and contact elements are provided to connect the cellular telephone. In order to ensure that the cellular telephone remains fixed in position even during travel involving significant vibration, latching elements and clamping elements are provided within the holding fixture.

In addition, a communications unit is provided comprising a telephone holder and an adapter according to the invention inserted into the telephone holder. As a result, adaptation to a specific cellular telephone may be implemented immediately when the telephone holder is purchased.

Alternatively, the communications unit comprises a cellular telephone and an adapter to accommodate the cellular telephone.

### BRIEF DESCRIPTION OF THE DRAWINGS

The following discussion explains the invention in more detail based on three embodiments with reference to the attached drawings.

FIG. 1A is a top view of a commercially available telephone holder;

FIG. 1B is a side view of the telephone holder of FIG. 1A;

FIG. 2A is a top view of a telephone holder including an adapter according to the invention in a first embodiment FIG. 2B is a side view of the telephone holder with the adapter of FIG. 2A;

FIG. 2C is a perspective view of the adapter in FIG. 2A;

FIG. 3A is a top view of a telephone holder including an adapter according to the invention in a second embodiment;

FIG. 3B is a side view of the telephone holder with the adapter as seen in FIG. 3A;

FIG. 4A is a top view of a telephone holder including an adapter according to the invention in a third embodiment;

FIG. 4B is a side view of the telephone holder with the adapter as seen in FIG. 4A; and

FIG. 5 is a top view of an antenna element for an adapter.

### DETAILED DESCRIPTION OF THE PREFERRED EMBODIMENT

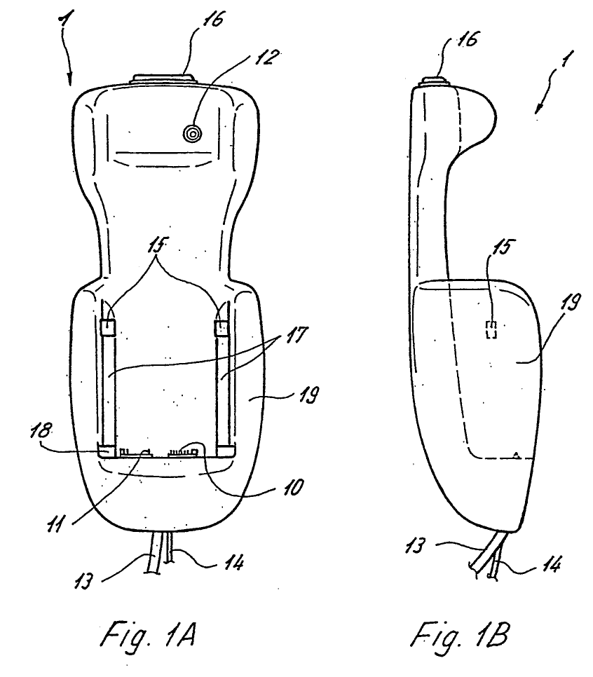

A telephone holder 1 of a hands-free device shown in FIGS. 1A through 1C includes multiple contact pins 10 and 11, the function of which is to enable the cellular telephone to be charged and signals to be transmitted. Telephone holder 1 has a shell-like base unit, an antenna plug 12 being provided in the upper region of the bottom of this base unit. Antenna plug 12 is connected to an antenna cord 14, while contact pins 10 and 11 are connected to a transmission cord 13. A specific type of cellular telephone may be connected to telephone holder 1.

Adjacent to side the side walls 19, locking elements 15 are provided to effect mechanical locking of a cellular telephone or adapter, the elements being located above a support strip 17. One section of support strip 17 here is configured to be pivotable at the top. When an object is pressed onto the pivotable section of strip 17, this section moves downward and aligns with strip 17 integral with side walls 19. The downward pivoting motion laterally pivots locking element 15 inward from the side wall which, as a result, is able to engage a recess in a cellular telephone or other object. A button 16 is provided to release the locking mechanism, which button releases the engaged locking elements 15 and uses a spring to enable the pivotable section of strip 17 to pivot back into the starting position. In addition, projections 18 are molded on to telephone holder 1 which facilitate locking of the cellular telephone or adapter and prevent these items from slipping out of the lock at the top.

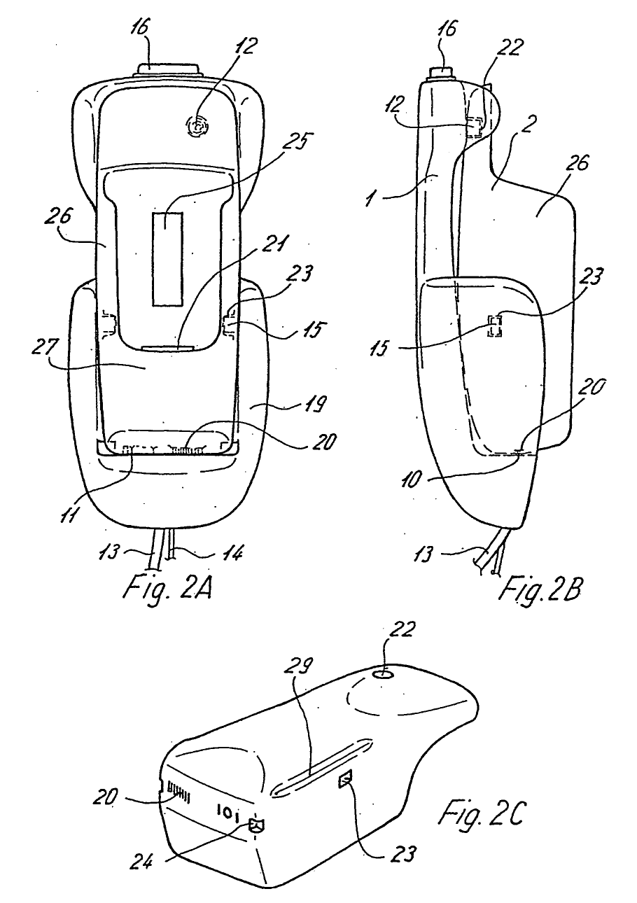

FIGS. 2A through 2C show telephone holder 1 including an adapter 2 according to the invention. Adapter 2 includes a contact strip 20 which is able to engage contact elements 10 and 11 of telephone holder 1. Adapter 2 is has essentially a box-like shape, a circuit board being enclosed within the plastic case of the adapter in the rear side facing telephone holder 1. In addition, a jack 22 is provided in adapter 2, into which jack antenna plug 12 may be inserted. In the opposite side walls of adapter 2, recesses 23 are provided which locking elements 15 of telephone holder 1 are able to engage. The rear side of adapter 2 has a support strip 29 which is able to rest on strip 17 of telephone holder 1. A recess 24 is then provided adjacent to contact strip 20; projections 18 of telephone holder 1 are able to engage said recess. In order to insert adapter 2, the contact strip is first placed onto contact elements 10 and 11 such that projections 18 engage recesses 24. Adapter 2 is then pivoted downward until strip 29 rests on strip 17, and locking element 15 laterally engages and latches into the respective recess 23 of adapter 2. In this pivoted-down position, adapter 2 is thus secured within telephone holder 1, while the contact elements engage each other.

Adapter 2 comprises side walls 26 and a pocket-shaped holding fixture 27 into which a cellular telephone may be inserted. In one part of pocket-shaped holding fixture 27, a plug element 21 is provided into which the cellular telephone may be inserted. To secure the cellular telephone, brush elements 25 may be provided at the base of adapter 2 and along side walls 26, which elements effect clamping forces to hold the cellular telephone within adapter 2. The adapter 2 shown includes only one plug 21 to connect cords for charging and to connect the requisite channels for the transmission of data.

Adapter 2 may optionally be left in telephone holder 1 and the cellular telephone may be plugged into adapter 2 when needed so that telephone calls may be placed via adapter 2 and telephone holder 1. Whenever telephone holder 1 is to be used for other types of telephones, adapter 2 may easily be removed by pressing button 6 and telephone holder 1 may be utilized in other ways.

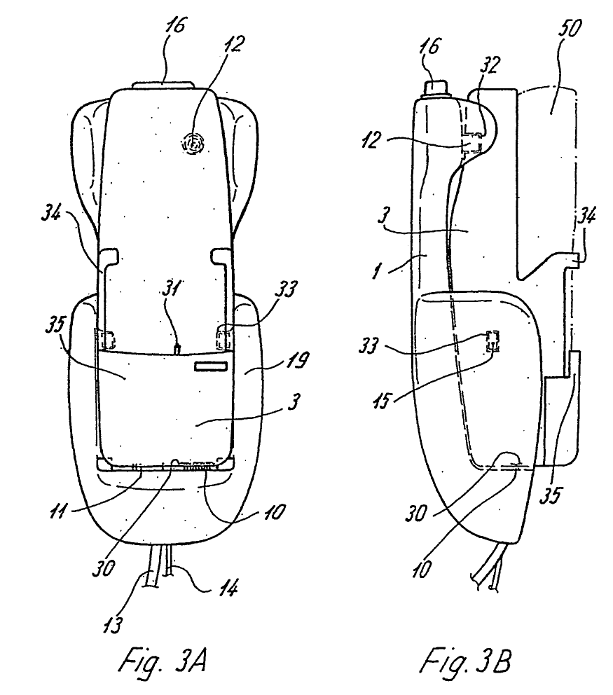

FIGS. 3A and 3B show a second embodiment of an adapter 3 according to the invention. Adapter 3 essentially has a box-like shape and includes a contact strip 30 and an antenna jack 32 which are positioned as in the previous embodiment so as to connect to telephone holder 1. The mechanical attachment means used to lock in telephone holder 1 are also of a similar design, recesses 33 being provided into which locking element 15 may be inserted. Locking and connection of adapter 3 are effected in a manner similar to that of the previous embodiment.

A pocket 35 is formed within adapter 3 to accommodate a cellular telephone 50. Cellular telephone 50 is retained by projecting side walls 34, brush surfaces being provided along the side walls and at additional locations on adapter 3 which utilize friction to reliably secure cellular telephone 50. Additional means of securing cellular telephone 50 may be provided as well. In order to connect cellular telephone 50, pins 31 are provided within holding fixture 35, which pins may be plugged into cellular telephone 50. Cellular telephone 50 is thus connected to telephone holder 1 through plug contacts 31, a circuit board not shown, contact strip 30, and contact elements 10 and 11, and is therefore functional. In the event cellular telephone 50 requires a different configuration in terms of transmission signals and power, an adaptation may be effected via the circuit board located in adapter 3.

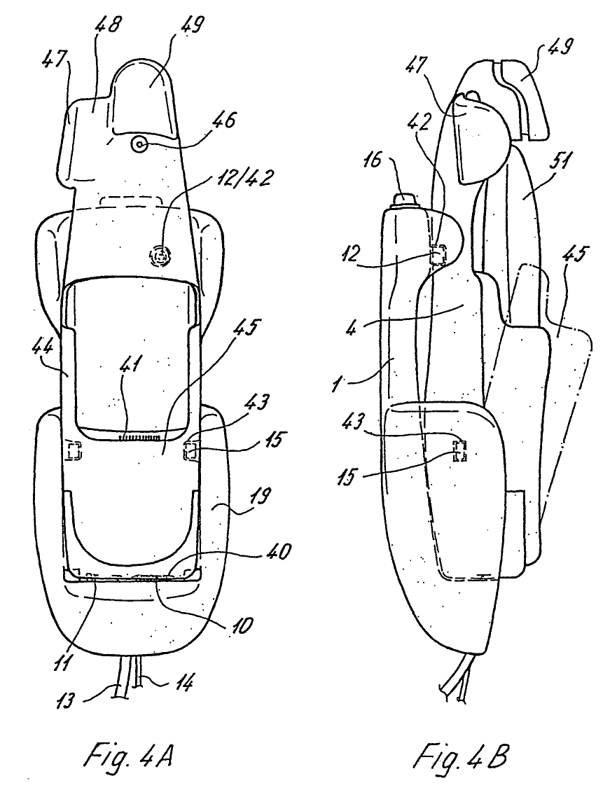

FIGS. 4A and 4B show a third embodiment of an adapter 4 according to the invention. Adapter 4 includes a shell insertable into telephone holder 1, on which a contact strip 40, a jack 42, and lateral recesses 43 are provided to enable adapter 4 to be connected to and engaged with telephone holder 1 in a manner similar to the previous embodiments.

To connect a cellular telephone 51, a holding fixture 45 is provided in which a plug strip 41 is mounted. Cellular telephone 51 may be slipped onto plug 41 by guiding it along the side walls 44. In the embodiment shown, holding fixture 45 is pivotably mounted so as to allow insertion of cellular telephone 51 only in the pivoted-open position. To lock in cellular telephone 51, the holding fixture along with cellular telephone 51 is pivoted downward until an antenna jack of cellular telephone 51 engages an antenna plug 46 on adapter 5. In this case, an antenna is mounted in a holding fixture 48, the antenna being accommodated in a protective manner by a side wall 47. Engagement of holding fixture 45 to cellular telephone 51 is effected by latching elements, not shown, beneath a switch 49. Pressing switch 49 retracts these latching elements, thus allowing holding fixture 45 to pivot upward by spring force.

The adapters 2, 3, and 4 shown have only a small selection of possible configurations for the adapter according to the invention. All of the adapters are able to be connected to an existing telephone retaining device 1, whereby the user has the option of removing the cellular telephone from the adapter or adapter from the telephone holder. In addition, when a new cellular telephone is purchased, one need only acquire an adapter additionally to be able to continue using an existing telephone retaining device.

The latching and locking means shown represent only a small selection of possible means of attachment. Any other type of clamping connection, latching connection or other quick-connection means may be utilized.

In the embodiments presented, one antenna plug 12, 46 is provided. In place of an antenna plug, or in addition to such a plug, an antenna element 60 may be enclosed in the adapter so as to be invisible from outside.

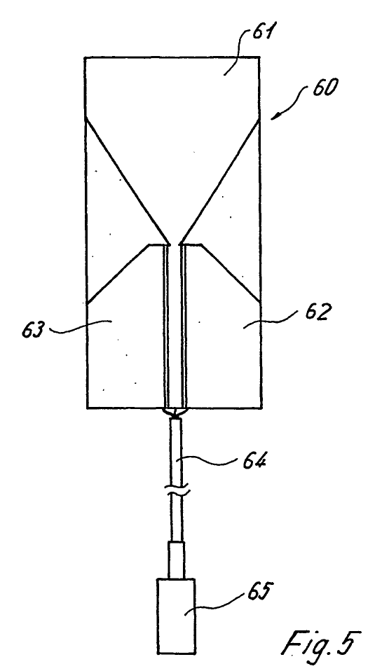

An antenna element 60 of this type is shown in FIG. 5. Antenna element 60 has a plate-like shape and has three conducting surfaces 61, 62, and 63 which are made of a thin metal layer, for example copper. Conducting surfaces 61, 62, and 63 are arranged on a plate composed of a plastic material so as to be fixed and separated from each other. Each conducting surface 61, 62 and 63 is connected through a terminal to a conductor of a cord 64. Cord 64 in turn is connected to a plug 65 which is connectable to a plug of telephone holder 1. Conducting surfaces 61, 62, 63 enable the reception of the cellular telephone to be improved since the path from the vehicle interior through cord 64 to telephone holder 1 and an antenna is bridged. The connection between antenna element 60 and the directly adjacent cellular telephone is subject to significantly less interference than the path from the cellular telephone extending out of the vehicle without antenna element 60. As a result, it is possible to have the cellular telephone obtain good reception without the contact of a plug, and to keep the radiation load within the vehicle low.

Antenna element 60 thus allows a kind of inductive antenna to be created. Antenna element 60 is accommodated within the adapter and may be enclosed within this adapter by cementing it in place, or encapsulating it by a foam or injection-molding process.

What is claimed is:

1. Adapter for a telephone holder of a hands-free device, specifically, for a telephone holder mounted in a vehicle, including a locking mechanism to detachably lock the adapter to the telephone holder, and a contact strip which is able to engage contact elements on the telephone holder, wherein a cellular telephone is insertable into the adapter, which telephone is detachably connectable to the adapter, and in the inserted position a connection is created between contact elements on the cellular telephone and contact elements on the adapter, and the cellular telephone on the telephone holder by the adapter, while retaining its functionality.

2. Adapter according to claim 1, wherein a circuit board is interconnected between the contact elements on the adapter and the contact strip.

3. Adapter according to claim 1, wherein the adapter has essentially a box-like shape, and a holding fixture is provided partially enclosing the cellular telephone.

4. Adapter according to one of claim 1, wherein lateral recesses are provided on the adapter which are insertable so as to secure the locking elements of the telephone holder.

5. Adapter according to one of claim 1, wherein support strips are provided on the adapter so as to slip on to projections located on the telephone holder.

6. Adapter according to one of claim 1, wherein the contact strip is provided on an end face of the box-shaped adapter, and recesses are present adjacent to the contact strip to engage projections on the telephone holder.

7. Adapter according to one of claim 1, wherein a jack for an antenna plug is provided on the rear side of the adapter facing the telephone holder.

8. Adapter according to one of claim 1, wherein the adapter has a pocket-shaped holding fixture for a cellular telephone, in which fixture the contact elements are located.

9. Adapter according to one of claim 1, wherein clamping elements are provided to secure the cellular telephone.

10. Adapter according to one of claim 1, wherein the holding fixture for the cellular telephone is pivotable and is latchable in the pivoted-down position.

11. Adapter according to one of claim 1, wherein the adapter has an antenna element which creates a non-contact connection to the cellular telephone.

12. Communications unit including a telephone holder, wherein an adapter according to claim 1 inserted into the telephone holder is provided.

13. Communications unit including a cellular telephone, wherein an adapter according to claim 1 is provided to accommodate the cellular telephone.
